(19) United States
(12) Patent Application Publication
(10) Pub. No.: US 2025/0294564 A1
(43) Pub. Date: Sep. 18, 2025

(54) PHYSICAL UPLINK CONTROL CHANNEL TRANSMISSION METHOD AND APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Xueyuan GAO, Beijing (CN)

(73) Assignee: BEIJING XIAOMI MOBILE SOFTWARE CO., LTD., Beijing (CN)

(21) Appl. No.: 18/861,213

(22) PCT Filed: Apr. 29, 2022
(86) PCT No.: PCT/CN2022/090654

§ 371 Date: Oct. 29, 2024

(51) Int. Cl. H04W 72/21; H04L 5/00

(52) U.S. Cl. CPC H04W 72/21; H04L 5/0048

(57) ABSTRACT

Embodiments of the present disclosure provide a PUCCH transmission method and apparatus, a communication device, and a storage medium. The PUCCH transmission method is executed by a terminal and comprises: according to a transmission configuration indicator (TCI), a plurality of antenna panels of the terminal perform non-coherent joint transmission (NC-JT) of a PUCCH on the basis of frequency-division multiplexing (FDM), different antenna panels corresponding to different TCIs.

### CROSS-REFERENCE TO RELATED APPLICATION

The application is a U.S. National Stage of International Application No. PCT/CN2022/090654 filed on Apr. 29, 2022, the entire content of which is incorporated herein by reference for all purposes.

### TECHNICAL FIELD

The present disclosure relates to the field of wireless communication technology, but is not limited to the field of wireless communication technology, and in particular, relates to a physical uplink control channel (PUCCH) transmission method and apparatus, a communication device and a storage medium.

### BACKGROUND

In order to improve coverage of the cell edge and provide a more balanced service quality within the service area, coordinated multiple point is still an important technical means in the New Radio (NR) system.

From the perspective of network form, network deployment with a large number of distributed access points and centralized baseband processing will be more conducive to providing a balanced user experience rate, and significantly reducing the delay and signaling overhead caused by handover.

As the frequency band increases, from the perspective of ensuring network coverage, relatively dense deployment of access points is also required. In the high frequency band, as the integration of active antenna equipment increases, it will be more inclined to adopt modular active antenna arrays. The antenna array of each Transmission Reception Point (TRP) can be divided into several relatively independent antenna panels. Thus, the form and number of ports of the entire array panel can be flexibly adjusted according to deployment scenarios and service needs.

The antenna panels or TRPs can also be connected by optical fibers for more flexible distributed deployment. In the millimeter wave band, as the wavelength decreases, the blocking effect caused by obstacles such as human bodies or vehicles will become more significant.

Therefore, from the perspective of ensuring the robustness of the link connection, coordination among multiple TRPs or antenna panels can also be used to perform transmission/reception through a plurality of beams facing the angles of multiple TRPs or antenna panels, thereby reducing the adverse effects caused by the blocking effect.

### SUMMARY

Embodiments of the present disclosure provide a PUCCH transmission method and apparatus, a communication device, and a storage medium.

The first aspect of the embodiments of the present disclosure provides a PUCCH transmission method, which is executed by a terminal. The method includes:
according to a transmission configuration indication (TCI), performing a non coherent-joint transmission (NC-JT) of a PUCCH by multiple antenna panels of the terminal based on frequency division multiplexing (FDM); where different antenna panels correspond to different TCIs.

The second aspect of the embodiments of the present disclosure provides a PUCCH transmission method, which is executed by a base station. The method includes:
receiving a non coherent-joint transmission (NC-JT) of a PUCCH performed by multiple antenna panels of one terminal based on frequency division multiplexing (FDM); where different antenna panels correspond to different transmission configuration indications (TCIs).

The third aspect of the embodiments of the present disclosure provides a PUCCH transmission apparatus, which is applied to a terminal. The apparatus includes:
a first transmission unit, configured to perform a non coherent-joint transmission (NC-JT) of a PUCCH based on frequency division multiplexing (FDM) through multiple antenna panels of the terminal according to a transmission configuration indication (TCI); where different antenna panels correspond to different TCIs.

The fourth aspect of the embodiments of the present disclosure provides a PUCCH transmission apparatus, which is applied to a base station. The apparatus includes:
a second transmission unit, configured to receive a non coherent-joint transmission (NC-JT) of a PUCCH performed by multiple antenna panels of one terminal based on frequency division multiplexing (FDM); where different antenna panels correspond to different transmission configuration indications (TCIs).

A fifth aspect of the embodiments of the present disclosure provides a communication apparatus, including a processor, a memory, and an executable program stored in the memory and capable of being run by the processor, where when the processor runs the executable program, the PUCCH transmission method provided in the first aspect is executed.

A sixth aspect of the embodiments of the present disclosure provides a computer storage medium that stores an executable program; after the executable program is executed by a processor, the PUCCH transmission method provided by the first aspect can be implemented.

In the technical solutions provided by the embodiments of the present disclosure, according to different antenna panels corresponding to different TCIs, multiple antenna panels of the terminal perform non coherent-joint transmission (NC-JT) of PUCCH based on FDM. In this way, the terminal can implement simultaneous uplink transmission by multiple antenna panels based on different TCIs, thereby improving the throughput of the communication system, and then improving the efficiency of uplink data transmission. In addition, NC-JT is performed based on multiple antenna panels, therefore the synchronization requirement of the transmission points for coordinated multiple point transmission can be reduced, thereby improving transmission reliability.

It should be understood that the above general description and the following detailed description are only exemplary and explanatory, and do not limit the embodiments of the present disclosure.

### BRIEF DESCRIPTION OF THE DRAWINGS

The accompanying drawings, which are incorporated in and constitute a part of this specification, illustrate embodiments consistent with the present disclosure, and together with the specification, serve to explain the principles of the embodiments of the present disclosure.

FIG. 1 is a schematic structural diagram of a wireless communication system according to an exemplary embodiment;

FIG. 2 is a schematic flowchart of a PUCCH transmission method according to an exemplary embodiment;

FIG. 3A is a schematic diagram of a single point transmission according to an exemplary embodiment;

FIG. 3B is a schematic diagram of an NC-JT according to an exemplary embodiment;

FIG. 3C is a schematic diagram of a C-JT according to an exemplary embodiment;

FIG. 4 is a schematic diagram of transmission of multiple antenna panels of a terminal according to an exemplary embodiment;

FIG. 5 is a schematic flowchart of a PUCCH transmission method according to an exemplary embodiment;

FIG. 6 is a schematic flowchart of a PUCCH transmission method according to an exemplary embodiment;

FIG. 7 is a schematic flowchart of a PUCCH transmission method according to an exemplary embodiment;

FIG. 8 is a schematic flowchart of a PUCCH transmission method according to an exemplary embodiment;

FIG. 9 is a schematic flowchart of a PUCCH transmission method according to an exemplary embodiment;

FIG. 10 is a schematic structural diagram of a PUCCH transmission apparatus according to an exemplary embodiment;

FIG. 11 is a schematic structural diagram of a PUCCH transmission apparatus according to an exemplary embodiment;

FIG. 12 is a schematic structural diagram of a terminal according to an exemplary embodiment; and

FIG. 13 is a schematic structural diagram of a communication apparatus according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with the embodiments of the present disclosure. Rather, they are merely examples of apparatus and methods consistent with some aspects of the embodiments of the present disclosure.

The terms used in the embodiments of the present disclosure are for the purpose of describing specific embodiments only and are not intended to limit the embodiments of the present disclosure. As used in the present disclosure, the singular forms “a/an,” “said” and “the” are intended to include the plural forms as well, unless the context clearly dictates otherwise. It will also be understood that the term “and/or” as used herein refers to and includes any or all possible combinations of one or more of the associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, the first information may also be called second information, and similarly, the second information may also be called first information. Depending on the context, the word “if” as used herein may be interpreted as “when” or “upon” or “in response to determining.”

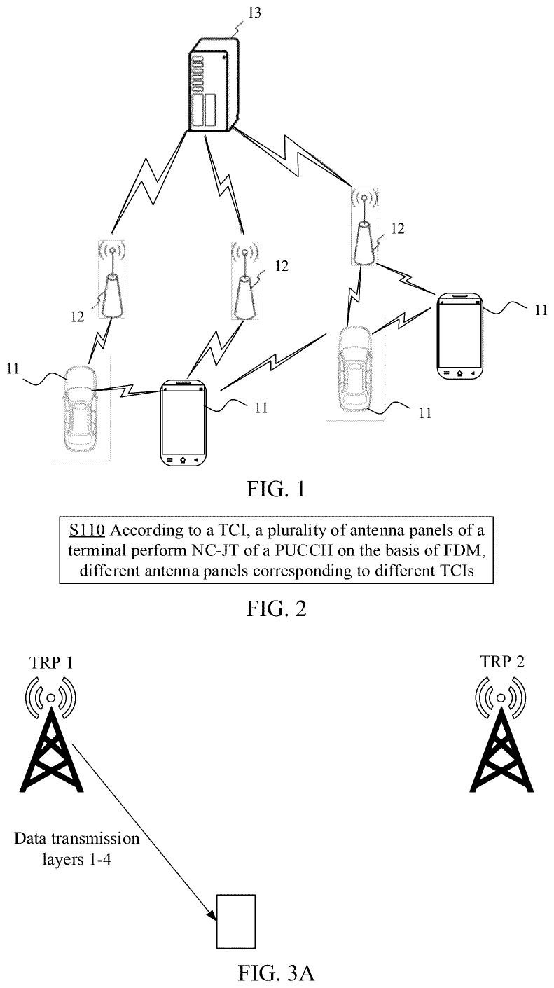

Referring to FIG. 1, a schematic structural diagram of a wireless communication system provided by an embodiment of the present disclosure is shown. As shown in FIG. 1, the wireless communication system is a communication system based on cellular mobile communication technology. The wireless communication system may include: several terminals 11 and several access devices 12.

The terminal 11 may be a device that provides voice and/or data connectivity to the user. The terminal 11 can communicate with one or more core networks via a Radio Access Network (RAN). The terminal 11 may be an Internet of Things terminal, such as a sensor device, a mobile phone (or “cellular” phone) and a computer with an Internet of Things terminal. For example, it may be a fixed, portable, pocket-sized, handheld, computer-built-in or vehicle-mounted apparatus, such as a station (STA), a subscriber unit, a subscriber station, a mobile station, a mobile, a remote station, an access point, a remote terminal, an access terminal, a user terminal, a user agent, a user device, or a user equipment (terminal). Alternatively, the terminal 11 may be a device of an unmanned aerial vehicle. Alternatively, the terminal 11 may also be a vehicle-mounted device, for example, it may be an on-board computer with a wireless communication function, or a wireless communication device externally connected to an on-board computer. Alternatively, the terminal 11 may also be a roadside device, for example, it may be a streetlight, a signal light or other roadside device with wireless communication function.

The access device 12 may be a network-side device in the wireless communication system. The wireless communication system may be the 4th generation mobile communication (4G) system, also known as the Long Term Evolution (LTE) system; or the wireless communication system may also be a 5G system, also called new radio (NR) system or 5G NR system. Alternatively, the wireless communication system may also be a next-generation system of the 5G system. The access network in the 5G system may be called New Generation-Radio Access Network (NG-RAN). Or, it may be an MTC system.

The access device 12 may be an evolved access device (eNB) used in the 4G system. Alternatively, the access device 12 may also be an access device (gNB) using a centralized and distributed architecture in the 5G system. When the access device 12 adopts the centralized and distributed architecture, it usually includes a central unit (CU) and at least two distributed units (DUs). The central unit is provided with protocol stacks of the Packet Data Convergence Protocol (PDCP) layer, the Radio Link Control protocol (Radio Link Control, RLC) layer, and the Media Access Control (MAC) layer; and the distributed unit is provided with a protocol stack of physical (PHY) layer, and the embodiments of the present disclosure do not limit the specific implementation of the access device 12.

A wireless connection can be established between the access device 12 and the terminal 11 through a wireless air interface. In different implementations, the wireless air interface is a wireless air interface based on the fourth generation mobile communication network technology (4G) standard; or the wireless air interface is a wireless air interface based on the fifth generation mobile communication network technology (5G) standard, for example, the wireless air interface is a new air interface; alternatively, the wireless air interface may also be a wireless air interface based on the next generation mobile communication network technology standard of 5G.

Optionally, the above wireless communication system may also include a network management device 13. Several access devices 12 are connected to the network management device 13 respectively. The network management device 13 may be a core network device in the wireless communication system. For example, the network management device 13 may be a mobility management entity (MME) in an evolved packet core network (Evolved Packet Core, EPC). Alternatively, the network management device may also be other core network devices, such as a serving gateway (SGW), a public data network gateway (PGW), a policy and charging rules function (PCRF) or a home subscriber server (HSS), etc. The embodiments of the present disclosure do not limit the implementation form of the network management device 13.

As shown in FIG. 2, an embodiment of the present disclosure provides a PUCCH transmission method, which is executed by a terminal. The method includes the following steps.

In S110: according to a TCI, multiple antenna panels of the terminal perform NC-JT of PUCCH based on FDM; where different antenna panels correspond to different TCIs.

In the embodiments of the present disclosure, one terminal may include multiple antenna panels for sending and receiving data, and each antenna panel may include at least one antenna element. Each antenna panel can correspond to one transmission reception point (TRP), and each antenna panel can be used to perform NC-JT transmission of PUCCH to the corresponding TRP.

In one embodiment, the TCI can be associated with a demodulation reference signal (Demodulation of Reference Signal, DMRS) port of the terminal. For example, the DMRS ports or DMRS port combinations associated with different TCIs are the same. One DMRS port combination may include at least one DMRS port. For example, a plurality of DMRS ports in one DMRS port combination may be Quasi-CoLocation (QCL).

Here, the non coherent-joint transmission (NC-JT) means that each uplink data is only mapped to QCL TRPs or ports corresponding to the antenna panel, and different uplink data can be mapped to different QCL ports without the need to treat all the transmission points uniformly as one virtual array.

The plurality of ports being QCL indicate that the specified large-scale parameters corresponding to the plurality of ports are the same, where the specified large-scale parameter may include at least one of Doppler frequency shift, Doppler spread, average delay, and delay spread. That is, as long as the specified large-scale parameters of a plurality of ports are consistent, regardless of whether there is difference in the actual physical locations of the plurality of ports or the orientations of the corresponding antenna panels, the plurality of ports can be considered to belong to the same location, that is, quasi-colocation (QCL).

For example, the DMRS ports in each code division multiplexing (CDM) group are QCL.

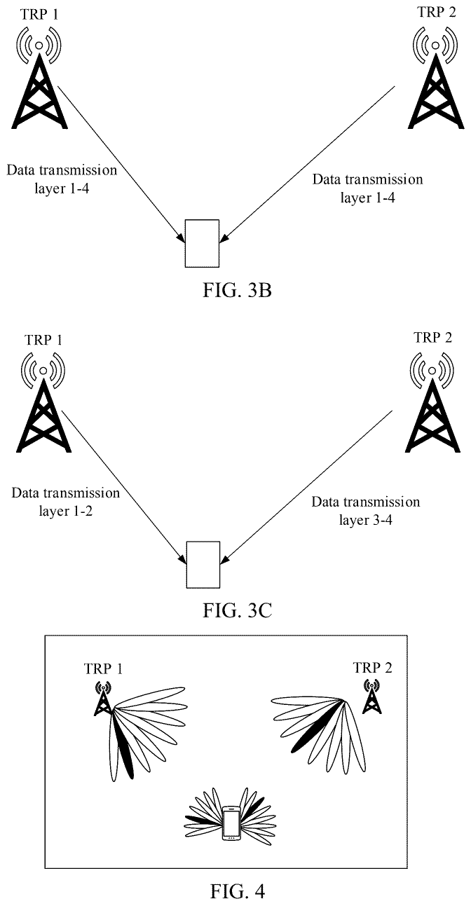

In one embodiment, as shown in FIGS. 3A, 3B and 3C, FIG. 3A is a schematic diagram of a transmission method of single-point transmission, FIG. 3B is a schematic diagram of a transmission method of coherent-joint transmission (C-JT), and FIG. 3C is a schematic diagram of a transmission method of NC-JT. The transmission reception point 1 and the transmission reception point 2 are transmission reception points (TRPs) corresponding to the antenna panel.

In the single-point transmission, the terminal receives the data transmission layers (Layer) 1-4 corresponding to all codewords from the same transmission reception point. In the C-JT transmission, the terminal receives the data transmission layers 1-4 corresponding to all codewords jointly precoded by the two transmission reception points from the two transmission reception points. In the NC-JT transmission, the terminal receives the data transmission layers 1-4 corresponding to the codewords from different transmission reception points. For example, the terminal receives two layers of data transmission layers 1-2 corresponding to codeword 0 from the transmission reception point 1, and receives two layers of data transmission layers 3-4 corresponding to codeword 1 from the transmission reception point 2.

For example, as shown in FIG. 4, one terminal includes two antenna panels, and the orientations of the two antenna panels may be opposite. The two antenna panels may be used to simultaneously send uplink data to the transmission reception point 1 and transmission reception point 2 of the base station respectively. For example, the uplink data may be uplink control information (UCI), etc.

In one embodiment, the NC-JT performed by the terminal to the TRP may be: a scheduling-free NC-JT, or a downlink control information (DCI)-scheduled NC-JT.

In one embodiment, in order to support transmission of different bit number ranges of UCI, PUCCH transmission can be divided into two categories from the perspective of carrying the bit number of UCI: one is a PUCCH format used to carry 1 to 2 bits of UCI transmission, and the other is a PUCCH format used to carry more than 2 bits of UCI transmission.

In another embodiment, from the perspective of uplink coverage and transmission delay, PUCCH transmission can also be divided into two categories: one is PUCCH transmission in short PUCCH format, occupying 1 or 2 symbols for transmission, and the other is PUCCH transmission in long PUCCH format, occupying 4 to 14 symbols for transmission.

Specifically, the PUCCH format may be shown in Table 1:

TABLE 1

| PUCCH | Symbol | | User reuse | Bit number |
|---|---|---|---|---|
| format | length | Number of RB | capacity | carried |
| 0 | 1-2 | 1 | 12 | ≤2 |
| 1 | 4-14 | 1 | 12* OCC length | ≤2 |
| 2 | 1-2 | 1, 2, . . . , 16 integer | 0 | >2 |
| 3 | 4-14 | 1, 2, 3, 4, 5, 6, 8, | 0 | >2 |
| | | 9, 10, 12, 15, 16 | | |
| 4 | 4-14 | 1 | 2 or 4 | >2 |

OCC is an orthogonal cover code (OCC). All PUCCH formats in Table 1 support intra-slot frequency hopping, while only PUCCH formats 1, 3 and 4 support inter-slot frequency hopping.

For PUCCH transmission of PUCCH formats 1, 3, and 4, the number of repetitions at the slot level can be configured through Radio Resource Control (RRC) signaling, and it can be repeatedly sent in a plurality of consecutive slots on the same time-frequency resource. The supported number of repetitions is 1, 2, 4 and 8. For PUCCH formats 0 and 2, the intra-slot repeated sending is not supported.

In one embodiment, the TCI corresponding to the antenna panel is used to indicate the beam direction of the beam emitted by the antenna panel. When different antenna panels correspond to different TCIs, each antenna panel has a separate TCI state, and thus each antenna panel has a separate beam emission direction. Multiple antenna panels can achieve non-overlapping beam directions. Therefore, multiple antenna panels are independent of each other and do not interfere with each other. In this way, multiple antenna panels of the terminal can be used to send uplink data to multiple TRPs of the base station.

In one embodiment, TCI may be indicated by one or more network signalings issued by the base station, for example, indicated to the terminal through downlink control information (DCI). Alternatively, TCI may be configured or indicated by a unified TCI framework. For example, the unified TCI framework can indicate a plurality of joint TCIs or a plurality of separate TCIs corresponding to multiple antenna panels to the terminal.

In one embodiment, if the beam correspondence of multiple panel/multiple TRP (MP/MTRP) is established, the unified TCI framework can indicate multiple different joint TCIs to TCIs of multiple antenna panels of the terminal.

If the consistency between the sending beam and the receiving beam of MP/MTRP is not established, the unified TCI framework can jointly indicate multiple separate TCIs to TCIs of multiple antenna panels of the terminal.

For example, assuming that the terminal has only two antenna panels, the terminal will be configured with two TCIs, which are simplified as TCI1 and TCI2 here. For example, antenna panel 1 corresponds to TCI1, and antenna panel 2 corresponds to TCI2.

In one embodiment, TCI may also be pre-agreed by the network protocol, or TCI may also be determined according to spatial relation information (Spatial Relation Info, SRI).

In one embodiment, one TCI may be associated with one piece of uplink control information (UCI) of the NC-JT transmission of the PUCCH. Different TCIs may be associated with the same UCI or different UCIs.

For example, when different TCIs are used for the transmission of the same UCI, multiple antenna panels of the terminal can simultaneously transmit one UCI, thereby improving the transmission gain and reliability of the UCI. When different TCIs are used for the transmission of different UCIs, multiple antenna panels of the terminal can transmit independently at the same time to realize the transmission of multiple UCIs, thereby improving the transmission efficiency of the UCI.

In one embodiment, according to TCI, multiple antenna panels of the terminal performing NC-JT of PUCCH based on frequency division multiplexing (FDM) may include: multiple antenna panels of the terminal determining a frequency domain resource corresponding to each antenna panel according to the corresponding TCI; performing NC-JT of PUCCH based on FDM between multiple frequency domain resources corresponding to the multiple antenna panels.

The frequency domain resource corresponding to each antenna panel can be determined according to the frequency domain resource corresponding to the PUCCH resource indicated by the PUCCH Resource Indicator (PRI). For example, when the PRI indicates one PUCCH resource, the frequency domain resources corresponding to different antenna panels are different parts in the frequency domain resources of the PUCCH resource. When the PRI indicates multiple PUCCH resources, the frequency domain resources corresponding to different antenna panels are the frequency domain resources corresponding to different PUCCH resources.

In this way, by configuring different TCIs for different antenna panels and using frequency division multiplexing (FDM), the terminal can achieve uplink transmission by multiple antenna panels at the same time, and the mutual interference among the multiple antenna panels is small, improving the throughput of the communication system, and thereby improving uplink data transmission efficiency. In addition, by performing NC-JT through multiple antenna panels, the synchronization requirement of the transmission points for coordinated multiple point transmission can be reduced, thereby improving transmission reliability.

In some embodiments, different antenna panels face different transmission reception points (TRPs) of the base station.

Here, different transmission reception points (TRPs) of a base station may include multiple different TRPs of the same base station, or may include different TRPs of multiple base stations.

In some embodiments, the time domain resources associated with different TCIs are the same and the frequency domain resources associated with different TCIs do not overlap.

In the embodiments of the present disclosure, if the time domain resources associated with different TCIs are the same, different antenna panels corresponding to different TCIs can achieve simultaneous transmission when transmitting UCI, and since different antenna panels point to different TRP directions, and the transmitted beam directions are also different, even if the time domain resources associated with different TCIs are the same, less interference can be generated.

If the frequency domain resources associated with different TCIs do not overlap, then when transmitting UCI, different antenna panels corresponding to different TCIs occupy different frequency domain resources, such as frequency bands, thereby reducing the interference caused by simultaneous uplink transmission of different antenna panels through frequency division multiplexing (FDM).

In some embodiments, the demodulation reference signal (DMRS) ports associated with different TCIs are the same.

In one embodiment, the DMRS port combinations associated with different TCIs are the same, where the DMRS port combination includes one DMRS port or multiple QCL DMRS ports.

In some embodiments, precoding matrices associated with different TCIs are independent.

Here, the precoding matrices (precoders) associated with different TCIs are different. The precoding matrix associated with TCI may be a precoding matrix preset in the terminal, or may be a precoding matrix indicated by the base station through issuing a network signaling. Different antenna panels corresponding to different TCIs perform NC-JT uplink transmission of PUCCH based on their respective precoding matrices.

In some embodiments, multiple antenna panels of the terminal perform the NC-JT of the PUCCH based on FDM within one PUCCH resource.

In the embodiment of the present disclosure, the PRI may indicate one PUCCH resource to the terminal for multiple antenna panels of the terminal to perform NC-JT of PUCCH based on FDM. At this time, the simultaneous uplink transmission of multiple antenna panels is NC-JT based on the same PUCCH resource.

Therefore, the time domain resources of TCI corresponding to multiple antenna panels are the same, and the time domain resource of TCI is the time domain resource corresponding to the one PUCCH resource. Based on FDM within one PUCCH resource, the time domain resources used by TCIs corresponding to different antenna panels are respectively part of the frequency domain resources corresponding to the one PUCCH resource.

In one embodiment, the frequency domain resources used by TCIs corresponding to different antenna panels do not overlap, and the frequency domain resources corresponding to one PUCCH resource are allocated to different TCIs, providing non-overlapping frequency domain resources for antenna panels corresponding to multiple TCIs.

In one embodiment, the frequency domain resource corresponding to one PUCCH resource is allocated to different TCIs according to a preset allocation rule. For example, the allocation rule can be indicated by PRI configuration, or can be pre-stored in the terminal, or can also be indicated by the base station through issuing an RRC signaling, etc.

For example, when the terminal only includes two antenna panels, antenna panel 1 and antenna panel 2 can respectively correspond to ½ or ⅓ of the frequency domain resource corresponding to the PUCCH resource, and the frequency domain resources corresponding to antenna panel 1 and antenna panel 2 do not overlap.

In one embodiment, antenna panels corresponding to different TCIs perform uplink transmission of the same UCI through respective different frequency domain resources. In this way, based on the allocation of the frequency domain resource corresponding to the same PUCCH resource to the antenna panels corresponding to multiple TCIs, coordinated transmission of multiple transmission points can be completed while occupying less PUCCH resources, and the transmission rate of UCI uplink transmission can be improved.

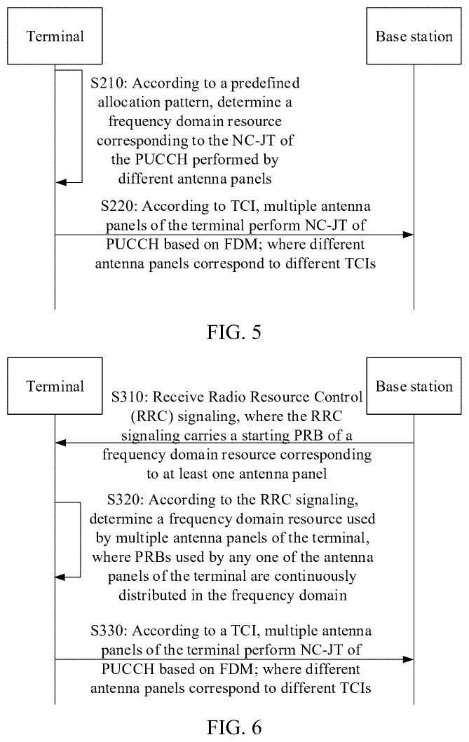

As shown in FIG. 5, an embodiment of the present disclosure provides a PUCCH transmission method, which is executed by a terminal. The method includes the following steps.

In S210: according to a predefined allocation pattern, frequency domain resources corresponding to the NC-JT of the PUCCH performed by different antenna panels are determined.

In S220: according to TCI, multiple antenna panels of the terminal perform NC-JT of PUCCH based on FDM; where different antenna panels correspond to different TCIs.

In the embodiments of the present disclosure, the predefined allocation pattern can be used to indicate information about frequency domain resources allocated to different antenna panels. The allocation pattern can be issued to the terminal by the base station through network signaling, etc., or can be stored in the terminal in advance.

In one embodiment, the predefined allocation pattern may be an allocation pattern of a predefined physical resource block (PRB), which is used to determine the distribution of the PRBs corresponding to the NC-JT of the PUCCH performed by different antenna panels. For example, the allocation pattern may indicate an average distribution of PRBs, or interval distribution of PRBs, etc.

Here, the average distribution of PRBs means that the number of PRBs corresponding to multiple antenna panels is the same or different, and the positions of multiple PRBs corresponding to each antenna panel are continuous.

Taking the number of antenna panels being 2 as an example, when the PRBs are evenly distributed, the PRBs corresponding to antenna panel 1 may be PRB1, PRB2, PRB3 and PRB4, etc., and the PRBs corresponding to antenna panel 2 may be PRB5, PRB6, PRB7 and PRB8, etc.

The interval distribution of PRBs indicates that the number of PRBs corresponding to multiple antenna panels is the same or different, and multiple PRBs corresponding to each antenna panel intersect with multiple PRBs corresponding to other antenna panel(s). For example, for two antenna panels, the two antenna panels correspond to odd-numbered PRBs and even-numbered PRBs, respectively.

Taking the number of antenna panels being 2 as an example, when the PRBs are distributed at intervals, the PRBs corresponding to antenna panel 1 may be PRB1, PRB3, PRB5 and PRB7, etc., and the PRBs corresponding to antenna panel 2 may be PRB2, PRB4, PRB6 and PRB8, etc.

In some embodiments, the physical resource blocks (PRBs) corresponding to any antenna panel of the terminal are continuously distributed in the frequency domain;
or,

PRBs corresponding to multiple antenna panels of the terminal are distributed at intervals in the frequency domain.

As shown in FIG. 6, an embodiment of the present disclosure provides a PUCCH transmission method, which is executed by a terminal. The method includes the following steps.

In S310: Radio Resource Control (RRC) signaling is received, where the RRC signaling carries a starting PRB of a frequency domain resource corresponding to at least one antenna panel.

In S320: according to the RRC signaling, a frequency domain resource used by multiple antenna panels of the terminal is determined, where the PRBs used by any one of the antenna panels of the terminal are continuously distributed in the frequency domain.

In S330: according to a TCI, multiple antenna panels of the terminal perform NC-JT of PUCCH based on FDM; where different antenna panels correspond to different TCIs.

In the embodiments of the present disclosure, for multiple antenna panels performing FDM within the same PUCCH resource, different antenna panels correspond to different PRBs in the frequency domain resource corresponding to the PUCCH resource. Therefore, the starting PRB of at least one PRB in the frequency domain resource associated with different antenna panels can be indicated through RRC signaling.

RRC signaling may be issued by the base station to the terminal, and the RRC signaling can carry information indicating the allocation of different frequency domain resources corresponding to antenna panels corresponding to different TCIs, such as information of PRB allocation corresponding to different antenna panels. The information of PRB allocation corresponding to different antenna panels may include the starting PRB corresponding to different antenna panels, and may also include all PRBs corresponding to different antenna panels.

In one embodiment, taking the terminal containing only two antenna panels as an example, the starting PRBs of antenna panel 1 and antenna panel 2 can both be carried and indicated by the RRC signaling.

In one embodiment, taking the terminal containing only two antenna panels as an example, the starting PRB of antenna panel 1 may be determined according to the indication of PRI, and the starting PRB of antenna panel 2 can be indicated by RRC signaling.

Embodiments of the present disclosure provide a PUCCH transmission method, which is executed by a terminal. The method includes:
receiving frequency hopping transmission indication information, where the frequency hopping transmission indication information includes: a frequency hopping indication bit, used to indicate the terminal to disable frequency hopping transmission; a frequency hopping starting PRB indication, used for the terminal to determine the starting PRB of the frequency domain resource used by at least one of the antenna panels, where the PRBs used by any one of the antenna panels of the terminal are continuously distributed in the frequency domain;
according to the frequency hopping transmission indication information, determining a frequency domain resource for multiple antenna panels to perform NC-JT of PUCCH based on FDM;
according to a TCI, multiple antenna panels of the terminal performing NC-JT of PUCCH based on FDM; where different antenna panels correspond to different TCIs.

In the embodiment of the present disclosure, for multiple antenna panels performing FDM within the same PUCCH resource, different antenna panels correspond to different PRBs in the frequency domain resource corresponding to the PUCCH resource. Therefore, the starting PRB of at least one PRB in the frequency domain resource associated with different antenna panels can be indicated through frequency hopping transmission indication information.

The frequency hopping transmission indication information can be indicated to the terminal by the PRI, or can be sent by the base station to the terminal through network signaling.

In one embodiment, taking the terminal containing only two antenna panels as an example, the frequency domain resource corresponding to the PUCCH resource is allocated to antenna panel 1 and antenna panel 2. The frequency hopping transmission indication information may indicate to determine the starting PRB of the frequency domain resource used by at least one antenna panel according to the PRB corresponding to at least one frequency hopping point of intra-slot frequency hopping. One slot of the intra-slot frequency hopping may contain multiple frequency hopping points, and different frequency hopping points correspond to different frequency bands.

In one embodiment, taking the terminal containing only two antenna panels as an example, the starting PRB of antenna panel 1 can be determined according to the indication of PRI, and the starting PRB of antenna panel 2 can be determined to be a PRB corresponding to the second frequency hopping point (second Hop PRB) of the intra-slot frequency hopping through the frequency hopping starting PRB indication.

Since at least one frequency hopping point PRB corresponding to the intra-slot frequency hopping of the PUCCH is used as the starting PRB of at least one antenna panel, by disabling the intra-slot frequency hopping, the occurrence of the starting PRB of the antenna panel being occupied by the frequency hopping transmission due to the intra-slot frequency hopping during uplink transmission can be reduced, thereby improving the PUCCH transmission reliability of the antenna panel.

In this way, the indication of the starting PRB of the frequency domain resource used by the antenna panel is carried by the frequency hopping transmission indication information, and there is no need to construct new network signaling or indication information, so that the indication of the starting PRB of the frequency domain resource used by the antenna panel can be efficiently completed by issuing the frequency hopping transmission indication information, and the efficiency of information transmission and resource indication can be improved.

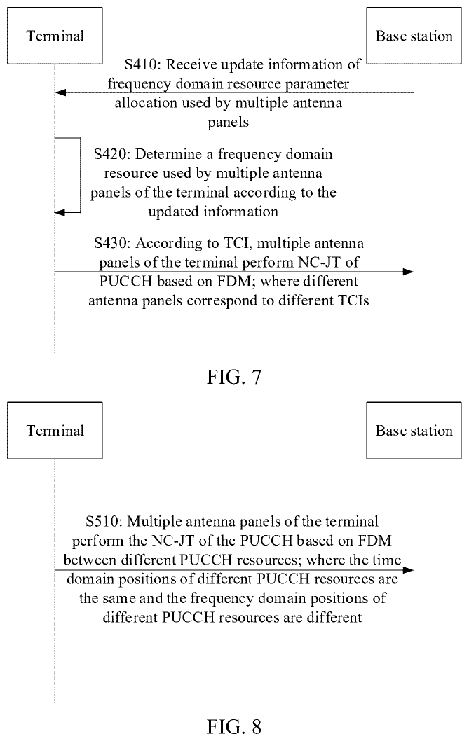

As shown in FIG. 7, an embodiment of the present disclosure provides a PUCCH transmission method, which is executed by a terminal. The method includes the following steps.

In S410: update information of frequency domain resource parameter allocation used by multiple antenna panels is received.

In S420: a frequency domain resource used by multiple antenna panels of the terminal is determined according to the updated information.

In S430: according to TCI, multiple antenna panels of the terminal perform NC-JT of PUCCH based on FDM; where different antenna panels correspond to different TCIs.

Here, the update information is used to indicate the frequency domain resource parameter allocation corresponding to different antenna panels. For example, the update information can be issued by indication of PRI, or can be carried and sent to the terminal by the base station through network signaling.

In some embodiments, receiving the updated information of the frequency domain resources used by multiple antenna panels includes:
receiving a media access control-control element (MAC-CE) containing the updated information.

In the embodiments of the present disclosure, the MAC-CE can be issued by the indication of PRI, or the base station can carry the message sent to the terminal through network signaling. The MAC-CE may carry a configuration identifier indicating the frequency domain resource parameter allocation used by multiple antenna panels, etc.

In some embodiments, the format of PUCCH transmission is: format 2 or format 3.

Here, since multiple antenna panels perform NC-JT of the PUCCH based on FDM within the same PUCCH resource, the PUCCH format needs to support multiple PRBs. That is, in combination with the multiple PUCCH formats in the above Table 1, it may be determined that when multiple antenna panels perform NC-JT of the PUCCH based on FDM within the same PUCCH resource, the supported PUCCH format is format 2 or format 3.

In some embodiments, the type of PUCCH transmission may include:

PUCCH transmission that does not support repeated transmission.

Here, when repeated transmission occurs, PUCCH transmission generates inter-slot frequency hopping or intra-slot frequency hopping, so that multiple transmissions can be performed in different slots or at different time points within the same slot. Therefore, the PUCCH transmission that does not support repeated transmission may be a PUCCH transmission that does not support inter-slot frequency hopping and/or intra-slot frequency hopping.

In some embodiments, the type of PUCCH transmission may include:

PUCCH repeated transmission based on intra-slot frequency hopping;

PUCCH repeated transmission based on inter-slot frequency hopping.

In one embodiment, since PUCCH repeated transmission based on intra-slot frequency hopping requires occupying PRBs corresponding to multiple frequency hopping points for repeated transmission (repetition), the frequency hopping point PRB is not supported as the starting PRB of the antenna panel.

Therefore, when the type of PUCCH transmission is PUCCH repeated transmission based on intra-slot frequency hopping, the starting PRB corresponding to the frequency domain resource used by at least one antenna panel can be determined based on RRC signaling, update information or MAC-CE, instead of determining the starting PRB corresponding to the frequency domain resource used by at least one antenna panel based on the frequency hopping transmission indication information.

As shown in FIG. 8, an embodiment of the present disclosure provides a PUCCH transmission method, which is executed by a terminal. The method includes the following steps.

In S510: multiple antenna panels of the terminal perform the NC-JT of the PUCCH based on FDM between different PUCCH resources; where the time domain positions of different PUCCH resources are the same and the frequency domain positions of different PUCCH resources are different.

In the embodiments of the present disclosure, different antenna panels correspond to different TCIs. PRI can indicate multiple PUCCH resources to the terminal, for multiple antenna panels of the terminal to perform NC-JT of PUCCH based on FDM. Different antenna panels can correspond to different PUCCH resources, or some antenna panels can correspond to the same PUCCH resource, and the PUCCH resources corresponding to the remaining antenna panels are different. At this time, the simultaneous uplink transmission of multiple antenna panels is NC-JT performed based on multiple different PUCCH resources.

In one embodiment, different antenna panels correspond to different PUCCH resources, and the time domain resource and frequency domain resource used by one antenna panel are both the time domain resource and frequency domain resource of one PUCCH resource corresponding to the antenna panel. The time domain resources of multiple PUCCH resources are the same. For example, multiple PUCCH resources occupy the same symbol in one slot, thereby achieving simultaneous uplink transmission of multiple antenna panels, and the frequency domain resources of multiple PUCCH resources do not overlap, thereby achieving that the frequency domain resources used by different antenna panels do not overlap, reducing the interference caused by the uplink transmission of multiple antenna panels to each other.

In one embodiment, the time domain resources and frequency domain resources corresponding to multiple PUCCH resources can be indicated by PRI.

In another embodiment, the occupation configuration of the time domain resource and frequency domain resource used by each antenna panel in the time domain resource and frequency domain resource of the corresponding PUCCH resource, can be indicated by the PRI.

In one embodiment, the PUCCH resource corresponding to each antenna panel can be indicated by the PRI, or can be pre-stored in the terminal, or can be indicated by the base station by issuing RRC signaling, etc.

For example, when the terminal only includes two antenna panels, antenna panel 1 and antenna panel 2 may correspond to PUCCH resource 1 and PUCCH resource 2 respectively, and the frequency domain resources corresponding to antenna panel 1 and antenna panel 2 do not overlap.

In one embodiment, antenna panels corresponding to different TCIs perform uplink transmission of the same UCI through the frequency domain resources corresponding to different PUCCH resources. In this way, based on the frequency domain resources corresponding to different PUCCH resources being allocated to antenna panels corresponding to multiple TCIs, each antenna panel can use more abundant frequency domain resources, so that the transmission code rate in each antenna panel-TRP transmission direction is high, and the stability and reliability of data uplink transmission are good.

In some embodiments, multiple antenna panels of the terminal perform the NC-JT of the PUCCH based on FDM between different PUCCH resources within the same PUCCH resource group;
or,
multiple antenna panels of the terminal perform the NC-JT of the PUCCH based on FDM between different PUCCH resources in different PUCCH resource groups;
where any two PUCCH resources in one PUCCH resource group have the same time domain position and different frequency domain positions.

In the embodiments of the present disclosure, PRI may be used to indicate one or more PUCCH resource groups, and each PUCCH resource group may include at least two PUCCH resources.

In one embodiment, the PRI may also indicate the PUCCH resource group corresponding to each antenna panel and the PUCCH resources in the PUCCH resource group.

In some embodiments, the PUCCH format supported by the PUCCH transmission includes:
PUCCH format 0;
PUCCH format 1;
PUCCH format 2;
PUCCH format 3;
PUCCH format 4.

Here, when different antenna panels respectively correspond to different PUCCH resources, each antenna panel performs NC-JT transmission of PUCCH resource based on independent PUCCH resource. Therefore, the PUCCH transmission corresponding to each antenna panel does not need to support multiple PRBs, and can support multiple PUCCH formats in the aforementioned Table 1.

In some embodiments, the type of PUCCH transmission includes:

PUCCH repeated transmission based on intra-slot frequency hopping;

PUCCH repeated transmission based on inter-slot frequency hopping; where the repeated transmission time domain configuration parameters of any two of the PUCCH resources are the same.

In the embodiments of the present disclosure, different antenna panels correspond to different PUCCH resources, and the time domain resources of different antenna panels are the same, so as to achieve simultaneous transmission of different antenna panels to different TRPs. Therefore, the repeated transmission time domain configuration parameters of any two PUCCH resources are the same. For example, the repeated transmission time domain configuration parameter may include at least one of the following: repeated transmission starting moment, repeated transmission period, and repeated transmission times.

In some embodiments, according to the transmission configuration indication (TCI), multiple antenna panels of the terminal performing non coherent-joint transmission (NC-JT) of PUCCH based on frequency division multiplexing (FDM), includes:
different antenna panels of the terminal performing non coherent-joint transmission (NC-JT) of PUCCH based on frequency division multiplexing (FDM) according to the corresponding TCI and target code rate.

In the embodiments of the present disclosure, the target code rate may be a transmission code rate of the antenna panel indicated by the PRI, where the target code rate may be indicated by the PRI, or may be indicated by the base station through RRC signaling, etc.

Different target code rates can indicate the data transmission rates when different antenna panels of the terminal perform NC-JT of PUCCH, for example, they can indicate the number of bits sent by different antenna panels per unit time, etc.

The target code rate may be determined by the modulation and coding strategy (MCS) used for PUCCH transmission of multiple antenna panels of the terminal, or agreed by network signaling sent by the base station or protocol.

In one embodiment, the target code rate may be a code rate that supports FDM within one PUCCH resource or FDM among multiple PUCCH resources.

In some embodiments, the PUCCH transmission includes: PUCCH transmission scheduled by single-downlink control information (S-DCI).

Here, the single-downlink control information (S-DCI) can be information transmitted downlink from the base station to the terminal. For example, S-DCI can be transmitted downlink by the base station through the physical downlink control channel (PDCCH) or the physical downlink shared channel (PDSCH).

In one embodiment, the S-DCI may indicate a transmission parameter and configuration information of PUCCH transmission, etc. For example, for NC-JT transmission of PUCCH, the S-DCI may indicate the time domain resource configuration parameter of the transmission, such as the repeated transmission cycle corresponding to repeated transmission based on inter-slot frequency hopping and other time domain resource configuration parameters.

In some embodiments, the TCI includes one of the following:
joint TCI;
separate TCI;
spatial relation information.

In the embodiments of the present disclosure, under the unified TCI framework configuration, TCI may include: joint TCI and separate TCI.

The joint TCI can be used to determine the direction of the uplink and downlink beams. The uplink beam is used for uplink transmission, and the downlink beam is used for downlink reception.

The separate TCI can be used in the direction of either the uplink beam or the downlink beam. For the beam direction of the uplink beam, separate TCI can indicate by UL TCI.

The spatial relation information may include a spatial relation information (SRI) combination. For example, the SRI combination may indicate spatialRelationInfo½.

In one embodiment, if the uplink beam directions of different antenna panels of the terminal are not indicated through joint TCI or separate TCI, spatial relation information may be used to indicate the uplink beam directions of different antenna panels of the terminal.

In some embodiments, indication information of the TCI has multiple TCI fields;
where one of the TCI fields indicates the TCI corresponding to one antenna panel of the terminal.

Here, one TCI field may contain one or more bits for indicating the TCI of one antenna panel of the terminal. TCIs of the antenna panels indicated by different TCI fields are different.

In some embodiments, the indication information of the TCI has one TCI field;
different code points in the TCI field indicate the TCIs corresponding to different antenna panels of the terminal.

In the embodiments of the present disclosure, the indication information of the TCI includes one unified TCI field. The TCI field includes one or more bits, and different bit values of these bits are different code points. Different code points in one TCI field can indicate the TCIs of multiple antenna panels of the terminal.

In one embodiment, the TCI field can be divided into multiple subfields, and one subfield indicates the TCI of one antenna panel. One subfield may include one or more bits.

In another embodiment, one code point in the TCI field corresponds to multiple combinations of TCIs at the same time.

In some embodiments, the TCI is carried by at least one of the following signalings:
downlink control information (DCI);

Media Access Control-Control Element (MAC-CE);
radio resource control (RRC) signaling.

In one embodiment, for PUCCH transmission configured with intra-slot frequency hopping, PUCCH transmission can be performed at each frequency hopping point based on the transmission method disclosed in one or more of the foregoing embodiments.

In one embodiment, for PUCCH transmission configured with inter-slot frequency hopping, PUCCH transmission can be performed at each slot-level frequency hopping point based on the transmission method disclosed in one or more of the foregoing embodiments.

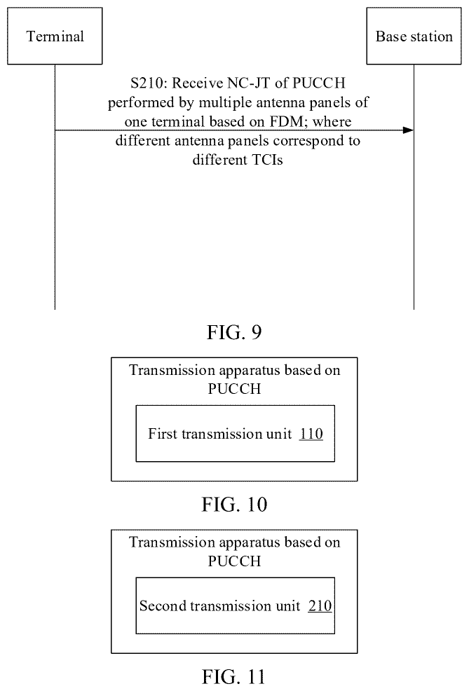

As shown in FIG. 9, an embodiment of the present disclosure provides a PUCCH transmission method, which is executed by a base station and may include the following steps.

In S210: NC-JT of PUCCH performed by multiple antenna panels of one terminal based on FDM is received; where different antenna panels correspond to different TCIs.

In the embodiments of the present disclosure, the base station can receive non coherent-joint transmission (NC-JT) of PUCCH performed by multiple antenna panels of one terminal based on frequency division multiplexing (FDM) through multiple TRPs, where different TRPs can correspond to different antenna panels, and each TRP is used to receive the NC-JT of the PUCCH performed by the corresponding antenna panel.

In one embodiment, the NC-JT received by the base station may be: a scheduling-free NC-JT, or a downlink control information (DCI)-scheduled NC-JT. For example, the base station issues DCI to the terminal to indicate scheduling of NC-JT.

In one embodiment, the base station can send DCI to the terminal to indicate the TCIs corresponding to different antenna panels of the terminal, or the base station can also configure the TCIs corresponding to different antenna panels of the terminal by indicating the unified TCI framework.

In one embodiment, if the beam correspondence of multiple antenna panels or multiple transmission reception points (Multiple Panel/Multiple TRP, MP/MTRP) is established, the base station can indicate multiple different joint TCIs to TCIs of multiple antenna panels of the terminal by indicating the unified TCI framework.

If the correspondence between the sending beam and the receiving beam of MP/MTRP is not established, the base station can jointly indicate multiple separate TCIs to the TCIs of multiple antenna panels of the terminal by indicating the unified TCI framework.

In one embodiment, the TCI can also be pre-agreed by the network protocol, or the TCI can also be determined based on the spatial relation information (Spatial Relation Info, SRI) indicated by the base station.

In one embodiment, the frequency domain resource corresponding to each antenna panel can be determined by the frequency domain resource corresponding to the PUCCH resource indicated by the base station through the PUCCH Resource Indicator (PRI). For example, when the base station indicates one PUCCH resource through PRI, the frequency domain resources corresponding to different antenna panels are different parts in the frequency domain resource of the PUCCH resource. When the base station indicates multiple PUCCH resources through PRI, the frequency domain resources corresponding to different antenna panels are the frequency domain resources corresponding to different PUCCH resources.

In some embodiments, different antenna panels face different transmission reception points (TRPs) of the base station.

Here, different transmission reception point (TRP) s of the base station may include multiple different TRPs of the same base station, or may include different TRPs of multiple base stations.

In some embodiments, the time domain resources associated with different TCIs are the same and the frequency domain resources associated with different TCIs do not overlap.

In some embodiments, the demodulation reference signal (DMRS) ports associated with different TCIs are the same.

In some embodiments, precoding matrices associated with different TCIs are independent.

In some embodiments, receiving the non coherent-joint transmission (NC-JT) of PUCCH performed by multiple antenna panels of one terminal based on frequency division multiplexing (FDM), includes:
receiving the NC-JT of the PUCCH performed by multiple antenna panels of one terminal based on FDM within one PUCCH resource.

In the embodiments of the present disclosure, the base station can indicate one PUCCH resource to the terminal through PRI, which is used for multiple antenna panels of the terminal to perform NC-JT of PUCCH based on FDM. At this time, the simultaneous uplink transmissions of multiple antenna panels received by multiple TRPs of the base station are NC-JT based on the same PUCCH resource.

Therefore, the time domain resources of TCI corresponding to multiple antenna panels are the same, and the time domain resource of TCI is the time domain resource corresponding to the one PUCCH resource. Based on FDM within one PUCCH resource, the time domain resources used by TCIs corresponding to different antenna panels are respectively part of the frequency domain resource corresponding to the one PUCCH resource.

In one embodiment, the frequency domain resources used by TCIs corresponding to different antenna panels do not overlap, and the frequency domain resource corresponding to one PUCCH resource are allocated to different TCIs, providing non-overlapping frequency domain resources for antenna panels corresponding to multiple TCIs. domain resources.

In one embodiment, the frequency domain resource corresponding to one PUCCH resource is allocated to different TCIs according to a preset allocation rule. For example, the allocation rule can be indicated by PRI configuration, or can be pre-stored in the terminal, or can also be indicated by the base station through issuing RRC signaling, etc.

In one embodiment, different TRPs of the base station receive the same UCI transmitted uplink by different antenna panels through respective different frequency domain resources. In this way, based on the allocation of the frequency domain resource corresponding to the same PUCCH resource to antenna panels corresponding to multiple TCIs, coordinated transmission of multiple transmission points can be completed while occupying less PUCCH resource, and the transmission rate of UCI uplink transmission can be improved.

Embodiments of the present disclosure provide a PUCCH transmission method, which is executed by a base station and may include: determining a frequency domain resource used by different antenna panels for performing NC-JT of the PUCCH according to a predefined allocation pattern;
receiving NC-JT of PUCCH performed by multiple antenna panels of one terminal based on FDM; where different antenna panels correspond to different TCIs.

In embodiments of the present disclosure, a predefined allocation pattern can be used to indicate information about frequency domain resources allocated to different antenna panels. The allocation pattern can be issued by the base station to the terminal through network signaling, etc.

In some embodiments, the method further includes:
sending frequency domain resource configuration information; where the frequency domain resource configuration information indicates that:
physical resource blocks (PRBs) corresponding to any antenna panel of the terminal are continuously distributed in the frequency domain;
or,

PRBs corresponding to multiple antenna panels of the terminal are distributed at intervals in the frequency domain.

Embodiments of the present disclosure provide a PUCCH transmission method, which is executed by a base station and may include: sending a radio resource control (RRC) signaling indicating a frequency domain resource used by multiple antenna panels of the terminal, where the RRC signaling carries a starting PRB of the frequency domain resource corresponding to at least one of the antenna panels; the PRBs used by any antenna panel of the terminal are continuously distributed in the frequency domain;
receiving NC-JT of PUCCH performed by multiple antenna panels of one terminal based on FDM; where different antenna panels correspond to different TCIs.

In the embodiments of the present disclosure, RRC signaling can be issued by the base station to the terminal. The RRC signaling can carry information indicating the allocation of different frequency domain resources corresponding to the antenna panels corresponding to different TCIs, such as information of the allocation of PRBs corresponding to different antenna panels. The information of the allocation of PRBs corresponding to different antenna panels may include starting PRBs corresponding to different antenna panels, and may also include all PRBs corresponding to different antenna panels.

Embodiments of the present disclosure provide a PUCCH transmission method, which is executed by a base station and may include: sending frequency hopping transmission indication information, where the frequency hopping transmission indication information includes:
a frequency hopping indication bit, used to instruct the terminal to disable frequency hopping transmission;
a frequency hopping starting PRB indication, used for the terminal to determine the starting PRB of the frequency domain resource used by at least one of the antenna panels, where the PRBs used by any one of the antenna panels of the terminal are continuously distributed in the frequency domain;
receiving NC-JT of PUCCH performed by multiple antenna panels of one terminal based on FDM; where different antenna panels correspond to different TCIs.

In the embodiments of the present disclosure, the frequency hopping transmission indication information can be indicated by the base station to the terminal through PRI, or can be sent by the base station to the terminal through network signaling.

In one embodiment, taking the terminal containing only two antenna panels as an example, the frequency domain resource corresponding to the PUCCH resource is allocated to antenna panel 1 and antenna panel 2. The frequency hopping transmission indication information may indicate that the starting PRB of the frequency domain resource used by at least one antenna panel is determined based on the PRB corresponding to at least one frequency hopping point of intra-slot frequency hopping. One slot of the intra-slot frequency hopping may contain multiple frequency hopping points, and different frequency hopping points correspond to different frequency bands.

In one embodiment, taking the terminal containing only two antenna panels as an example, the starting PRB of antenna panel 1 can be determined according to the indication of PRI, and the starting PRB of antenna panel 2 can be determined as the PRB (second Hop PRB) corresponding to the second frequency hopping point in the intra-slot frequency hopping through the frequency hopping starting PRB indication.

Since at least one frequency hopping point PRB corresponding to the intra-slot frequency hopping of the PUCCH is used as the starting PRB of at least one antenna panel, by disabling the intra-slot frequency hopping, the occurrence of the starting PRB of the antenna panel being occupied by the frequency hopping transmission due to the intra-slot frequency hopping during uplink transmission can be reduced, thereby improving the PUCCH transmission reliability of the antenna panel.

In this way, by carrying the indication of the starting PRB of the frequency domain resource used by the antenna panel in the frequency hopping transmission indication information, the base station does not need to construct new network signaling or indication information, and thus the indication of the starting PRB of the frequency domain resource used by the antenna panel can be efficiently completed by issuing the frequency hopping transmission indication information, and the efficiency of information transmission and resource indication can be improved.

Embodiments of the present disclosure provide a PUCCH transmission method, which is executed by a base station and may include: sending update information; where the update information is used to determine frequency domain resource parameter allocation used by multiple antenna panels;
receiving NC-JT of PUCCH performed by multiple antenna panels of one terminal based on FDM; where different antenna panels correspond to different TCIs.

Here, the update information is used to indicate the frequency domain resource parameter allocation corresponding to different antenna panels. For example, the update information can be issued by the base station through indication of PRI, or can be carried and sent to the terminal by the base station through network signaling.

In some embodiments, sending update information includes:
sending a media access control-control element (MAC-CE) containing the updated information.

In the embodiments of the present disclosure, the MAC-CE can be issued by the base station through the indication of PRI, or the base station can carry a message sent to the terminal through network signaling. The MAC-CE may carry a configuration identifier indicating the frequency domain resource parameter allocation used by multiple antenna panels, etc.

In some embodiments, the format of PUCCH transmission is: format 2 or format 3.

In some embodiments, the type of PUCCH transmission includes:

PUCCH transmission that does not support repeated transmission.

In some embodiments, the type of PUCCH transmission includes:
PUCCH repeated transmission based on intra-slot frequency hopping;

PUCCH repeated transmission based on inter-slot frequency hopping.

In some embodiments, receiving non coherent-joint transmission (NC-JT) of PUCCH

performed multiple antenna panels of one terminal based on frequency division multiplexing (FDM), includes:
receiving the NC-JT of the PUCCH performed by multiple antenna panels of one terminal based on FDM between different PUCCH resources;
where time domain positions of different PUCCH resources are the same and frequency domain positions of different PUCCH resources are different.

In the embodiments of the present disclosure, the base station can indicate multiple PUCCH resources to the terminal through PRI, for multiple antenna panels of the terminal to perform NC-JT of PUCCH based on FDM, where different antenna panels can correspond to different PUCCH resources, or, some antenna panels may correspond to the same PUCCH resources, and the PUCCH resources corresponding to the remaining antenna panels are different. At this time, the simultaneous uplink transmission received by multiple TRPs of the base station from multiple antenna panels is NC-JT performed based on multiple different PUCCH resources.

In one embodiment, the time domain resource and frequency domain resource corresponding to multiple PUCCH resources can be indicated by PRI.

In another embodiment, the base station can also indicate through the PRI: the occupation configuration of the time domain resource and frequency domain resource used by each antenna panel in the time domain resource and frequency domain resource of the corresponding PUCCH resource.

In one embodiment, the base station can also indicate the PUCCH resource corresponding to each antenna panel through PRI or by issuing RRC signaling.

In one embodiment, different TRPs of the base station receive uplink transmission of the same UCI by different antenna panels through frequency domain resources of different PUCCH resources. In this way, based on the frequency domain resources corresponding to different PUCCH resources being allocated to antenna panels corresponding to multiple TCIs, each antenna panel can use more abundant frequency domain resources, so that the transmission code rate in each antenna panel-TRP transmission direction is high, and the stability and reliability of data uplink transmission are good.

In some embodiments, receiving the NC-JT of the PUCCH performed by multiple antenna panels of one terminal based on FDM between different PUCCH resources, includes:
receiving the NC-JT of the PUCCH performed by multiple antenna panels of one terminal based on FDM between different PUCCH resources within the same PUCCH resource group;
or,
receiving the NC-JT of the PUCCH performed by multiple antenna panels of one terminal based on FDM between different PUCCH resources in different PUCCH resource groups;
where any two PUCCH resources in one PUCCH resource group have the same time domain position and different frequency domain positions.

In the embodiments of the present disclosure, the base station may indicate one or more PUCCH resource groups through PRI, and each PUCCH resource group may include at least two PUCCH resources.

In one embodiment, the base station may also indicate, through PRI, the PUCCH resource group corresponding to each antenna panel and the PUCCH resources in the PUCCH resource group.

In some embodiments, the PUCCH format supported by the PUCCH transmission includes:
PUCCH format 0;
PUCCH format 1;
PUCCH format 2;
PUCCH format 3;
PUCCH format 4.

In some embodiments, the type of PUCCH transmission includes:

PUCCH repeated transmission based on intra-slot frequency hopping;

PUCCH repeated transmission based on inter-slot frequency hopping; where the repeated transmission time domain configuration parameters of any two of the PUCCH resources are the same.

In some embodiments, the method further includes:
sending target code rate configuration information; where the target code rate indicated by the target code rate configuration information and the TCI are used for the terminal to perform NC-JT of PUCCH based on FDM.

In some embodiments, the method further includes:
sending single-downlink control information (S-DCI); the S-DCI is used to schedule the transmission of the PUCCH.

In some embodiments, the TCI includes one of the following:
a joint TCI;
a separate TCI;
spatial relation information.

In some embodiments, the indication information of the TCI has multiple TCI fields;
one of the TCI fields indicates the TCI corresponding to one antenna panel of the terminal.

In some embodiments, the indication information of the TCI has one TCI field;
different code points in the TCI field indicate the TCIs corresponding to different antenna panels of the terminal.

In some embodiments, the TCI is carried by at least one of the following signalings:
downlink control information (DCI);
media access control-control element (MAC-CE);
radio resource control (RRC) signaling.

Embodiments of the present disclosure provide a PUCCH transmission scheme for multiple antenna panels to simultaneously send uplink data to multiple TRPs. The details may be as follows.

It is considered to configure to activate/indicate the terminal N TCI states suitable for simultaneous transmission based on the unified TCI framework. Depending on whether the multiple antenna panel-multiple TRP (Multiple Panel/Multiple TRP, MP/MTRP) beam correspondence is established, specifically, N Different joint TCIs or N separate TCIs may be jointly indicated to the terminal.

When N=2, it is simplified as TCI1 and TCI2 . Each TCI corresponds to the sending/receiving beam of one antenna panel of the terminal and faces one sending TRP direction. Each TCI contains a different QCL Type-D source RS. The terminal uses the antenna panel corresponding to the QCL Type-D source RS contained in the TCI for reception. When unified TCI is not configured, spatialRelationInfo½ indicated by the SRI combination is used.

The NC-JT transmission method based on FDM of PUCCH includes the following two solutions:

### First Solution

1. For one PUCCH resource indicated by PRI, the same UCI data is mapped to non-overlapping frequency domain resources corresponding to the same time domain resource through TCI1and TCI2 corresponding to different antenna panels and TRPs. Different TCIs are associated with different frequency domain resources, and the same DMRS port.
2. It is considered to define the corresponding resource allocation method between TRPs:
1) predefining the allocation pattern between PRBs, such as an average PRB allocation, or an interval PRB allocation;
2) configuring a second starting PRB (startingPRB) through RRC, which is used to indicate the starting PRB of frequency domain resource allocation corresponding to the second TCI;
3) by disabling intra-slot frequency hopping, using secondHopPRB to indicate the starting PRB in the frequency domain corresponding to the second TCI;
4) allowing configuration updates through MAC-CE.
3. Different TCIs use different precoders for precoding, and the corresponding antenna panels use their respective precoders to send PUCCH.
4. Only PUCCH transmission formats 2 and 3 are supported (only formats 2 and 3 support the allocation of multiple PRBs).
5. Different transmission schemes for PUCCH resources are supported, including no repeated transmission (repetition), and configuring repeated transmission based on slot and alternative slot (slot/sub-slot) in the same slot or multiple slots.
6. For PUCCH resources configured with intra-slot frequency hopping, the above-mentioned FDM method can be used for transmission at each frequency hopping point (hop).
7. For PUCCH resources configured with inter-slot frequency hopping, the above-mentioned FDM method can be used for transmission on hop of each slot-level.
8. The configured target code rate allows FDM PUCCH resources.

### Second Solution

1. For two different PUCCH resources belonging to the same or different PUCCH groups, the two resources occupy the same time domain resources and different frequency domain resources, (can be jointly indicated by PRI), and the same UCI data is mapped to non-overlapping frequency domain resources corresponding to the same time domain resource through TCI1and TCI2 being respectively associated with and corresponding to different panels/TRPs. Different TCIs are associated with different frequency domain resources and the same DMRS port of PUCCH.
2. Different TCIs apply different precoding matrices (precoders) for precoding, and the corresponding antenna panels use their own precoder to send according to their respective PUCCH resource configurations.
3. All formats of PUCCH transmission are supported; the time domain resource configuration of the two PUCCH resources is the same, that is, they occupy the same symbol in one slot.
4. Different transmission schemes for PUCCH resources are supported, including no repeated transmission, and configuring repeated transmission based on slot/sub-slot in the same slot or multiple slots; the time domain repetition parameter configuration of different PUCCH resources is the same.
5. For PUCCH resources configured with intra-slot frequency hopping, the above-mentioned FDM method can be used for transmission on each hop.
6. For PUCCH resources configured with inter-slot frequency hopping, the above-mentioned FDM method can be used for transmission on each slot-level hop.

As shown in FIG. 10, an embodiment of the present disclosure provides a PUCCH transmission apparatus, which is applied to a terminal and may include:
a first transmission unit 110, configured to perform non coherent-joint transmission (NC-JT) of PUCCH based on frequency division multiplexing (FDM) through multiple antenna panels of the terminal according to a transmission configuration indication (TCI); where different antenna panels correspond to different TCIs.

In some embodiments, different antenna panels face different transmission reception points (TRPs) of a base station.

In some embodiments, time domain resources associated with different TCIs are the same and frequency domain resources associated with different TCIs do not overlap.

In some embodiments, demodulation reference signal (DMRS) ports associated with different TCIs are the same.

In some embodiments, precoding matrices associated with different TCIs are independent.

In some embodiments, the multiple antenna panels of the terminal perform the NC-JT of the PUCCH based on FDM within one PUCCH resource.

In some embodiments, the first transmission unit is further configured to:
according to a predefined allocation pattern, determine a frequency domain resource used by different antenna panels for performing the NC-JT of the PUCCH.

In some embodiments, physical resource blocks (PRBs) corresponding to any one of the antenna panels of the terminal are continuously distributed in a frequency domain;
or,

PRBs corresponding to the multiple antenna panels of the terminal are distributed at intervals in the frequency domain.

In some embodiments, the apparatus further includes:
a first receiving unit, configured to receive a radio resource control (RRC) signaling, where the RRC signaling carries a starting PRB of a frequency domain resource corresponding to at least one of the antenna panels;
the first transmission unit 110 is further configured to determine a frequency domain resource used by the multiple antenna panels of the terminal according to the RRC signaling, where PRBs used by any one of the antenna panels of the terminal are continuously distributed in a frequency domain.

In some embodiments, the apparatus further includes:
a second receiving unit, configured to receive frequency hopping transmission indication information, where the frequency hopping transmission indication information includes:
a frequency hopping indication bit, configured to indicate the terminal to disable frequency hopping transmission;
a frequency hopping starting PRB indication, configured for the terminal to determine a starting PRB of a frequency domain resource used by at least one of the antenna panels, where PRBs used by any one of the antenna panels of the terminal are continuously distributed in a frequency domain.

In some embodiments, the apparatus further includes:
a third receiving unit, configured to receive update information of a frequency domain resource parameter allocation used by the multiple antenna panels;
the first transmission unit 110 is further configured to determine a frequency domain resource used by the multiple antenna panels of the terminal based on the updated information.

In some embodiments, the third receiving unit is specifically configured to:
receive a media access control-control element (MAC-CE) containing the updated information.

In some embodiments, a format of the PUCCH transmission is: a format 2 or a format 3.

In some embodiments, a type of the PUCCH transmission includes:

PUCCH transmission that does not support a repeated transmission.

In some embodiments, a type of the PUCCH transmission includes:
a PUCCH repeated transmission based on intra-slot frequency hopping;
a PUCCH repeated transmission based on inter-slot frequency hopping.

In some embodiments, the multiple antenna panels of the terminal perform the NC-JT of the PUCCH based on FDM between different PUCCH resources;
where different PUCCH resources have a same time domain position and different frequency domain positions.

In some embodiments, multiple antenna panels of the terminal perform the NC-JT of the PUCCH based on FDM between different PUCCH resources within a same PUCCH resource group;
or,
the multiple antenna panels of the terminal perform the NC-JT of the PUCCH based on FDM between different PUCCH resources in different PUCCH resource groups;
where any two of the PUCCH resources in one PUCCH resource group have a same time domain position and different frequency domain positions.

In some embodiments, a PUCCH format supported by the PUCCH transmission includes:
a PUCCH format 0;
a PUCCH format 1;
a PUCCH format 2;
a PUCCH format 3;
a PUCCH format 4.

In some embodiments, a type of the PUCCH transmission includes:
a PUCCH repeated transmission based on intra-slot frequency hopping;
a PUCCH repeated transmission based on inter-slot frequency hopping; where repeated transmission time domain configuration parameters of any two of the PUCCH resources are the same.

In some embodiments, the first transmission unit 110 is specifically configured to:
perform the non coherent-joint transmission (NC-JT) of PUCCH by different antenna panels of the terminal based on frequency division multiplexing (FDM) according to a corresponding TCI and target code rate.

In some embodiments, the PUCCH transmission includes: a PUCCH transmission scheduled by single-downlink control information (S-DCI).

In some embodiments, the TCI includes one of the following:
a joint TCI;
a separate TCI;
spatial relation information.

In some embodiments, indication information of the TCI has multiple TCI fields;
one of the TCI fields indicates a TCI corresponding to one antenna panel of the terminal.

In some embodiments, indication information of the TCI has one TCI field;
different code points in the TCI field indicate TCIs corresponding to different antenna panels of the terminal.

In some embodiments, the TCI is carried by at least one of the following signalings:
downlink control information (DCI);
media access control-control element (MAC-CE);
radio resource control (RRC) signaling.

As shown in FIG. 11, an embodiment of the present disclosure provides a PUCCH transmission apparatus, which is applied to a base station and may include:
a second transmission unit 210, configured to receive non coherent-joint transmission (NC-JT) of PUCCH performed by multiple antenna panels of one terminal based on frequency division multiplexing (FDM); where different antenna panels correspond to different transmission configuration indications (TCIs).

In some embodiments, different antenna panels face different transmission reception points (TRPs) of the base station.

In some embodiments, time domain resources associated with different TCIs are the same, and frequency domain resources associated with different TCIs do not overlap.

In some embodiments, demodulation reference signal (DMRS) ports associated with different TCIs are the same.

In some embodiments, precoding matrices associated with different TCIs are independent.

In some embodiments, the second transmission unit 210 is specifically configured to:
receive the NC-JT of the PUCCH performed by the multiple antenna panels of one terminal based on FDM within one PUCCH resource.

In some embodiments, the second transmission unit 210 is further configured to:
according to a predefined allocation pattern, determine frequency domain resources used by different antenna panels for performing the NC-JT of the PUCCH.

In some embodiments, the apparatus further includes:
a first sending unit, configured to send frequency domain resource configuration information; where the frequency domain resource configuration information indicates that:
physical resource blocks (PRBs) corresponding to any one of the antenna panels of the terminal are continuously distributed in a frequency domain;
or,

PRBs corresponding to the multiple antenna panels of the terminal are distributed at intervals in the frequency domain.

In some embodiments, the apparatus further includes:
a second sending unit, configured to send a radio resource control (RRC) signaling indicating a frequency domain resource used by the multiple antenna panels of the terminal, where the RRC signaling carries a starting PRB of the frequency domain resource used by at least one of the antenna panels; and PRBs used by any one of the antenna panels of the terminal are continuously distributed in a frequency domain.

In some embodiments, the apparatus further includes:
a third sending unit, configured to send frequency hopping transmission indication information, where the frequency hopping transmission indication information includes:
a frequency hopping indication bit, configured to indicate the terminal to disable frequency hopping transmission;
a frequency hopping starting PRB indication, configured for the terminal to determine a starting PRB of a frequency domain resource used by at least one of the antenna panels, where PRBs used by any one of the antenna panels of the terminal are continuously distributed in a frequency domain.

In some embodiments, the apparatus further includes:
a fourth sending unit, configured to send update information; where the update information is configured to determine a frequency domain resource parameter allocation used by the multiple antenna panels.

In some embodiments, the fourth sending unit is specifically configured to:
send a media access control-control element (MAC-CE) containing the updated information.

In some embodiments, a format of the PUCCH transmission is: a format 2 or a format 3.

In some embodiments, a type of the PUCCH transmission includes:
a PUCCH transmission that does not support a repeated transmission.

In some embodiments, a type of the PUCCH transmission includes:
a PUCCH transmission based on intra-slot frequency hopping;
a PUCCH repeated transmission based on inter-slot frequency hopping.

In some embodiments, the second transmission unit 210 is specifically configured to:
receive the NC-JT of the PUCCH performed by the multiple antenna panels of one terminal based on FDM between different PUCCH resources;
where different PUCCH resources have a same time domain position and different frequency domain positions.

In some embodiments, the second transmission unit 210 is specifically configured to:
receive the NC-JT of the PUCCH performed by the multiple antenna panels of one terminal based on FDM between different PUCCH resources within a same PUCCH resource group;
or,
receive the NC-JT of the PUCCH performed by the multiple antenna panels of one

terminal based on FDM between different PUCCH resources within different PUCCH resource groups;
where any two of the PUCCH resources in one PUCCH resource group have a same time domain position and different frequency domain positions.

In some embodiments, a PUCCH format supported by the PUCCH transmission includes:
a PUCCH format 0;
a PUCCH format 1;
a PUCCH format 2;
a PUCCH format 3;
a PUCCH format 4.

In some embodiments, a type of PUCCH transmission includes:
a PUCCH repeated transmission based on intra-slot frequency hopping;
a PUCCH repeated transmission based on inter-slot frequency hopping; where repeated transmission time domain configuration parameters of any two of the PUCCH resources are the same.

In some embodiments, the apparatus further includes:
a fifth sending unit, configured to send target code rate configuration information; where the target code rate indicated by the target code rate configuration information and the TCI are used for the terminal to perform the NC-JT of the PUCCH based on FDM.

In some embodiments, the apparatus further includes:
a sixth sending unit, configured to send single-downlink control information (S-DCI); where the S-DCI is used to schedule a transmission of the PUCCH.

In some embodiments, the TCI includes one of the following:
a joint TCI;
a separate TCI;
spatial relation information.

In some embodiments, indication information of the TCI has multiple TCI fields;
one of the TCI fields indicates a TCI corresponding to one antenna panel of the terminal.

In some embodiments, indication information of the TCI has one TCI field;
different code points in the TCI field indicate TCIs corresponding to different antenna panels of the terminal.

In some embodiments, the TCI is carried by at least one of the following signalings:
downlink control information (DCI);
media access control-control element (MAC-CE);
radio resource control (RRC) signaling.

An embodiment of the present disclosure provides a communication device, including:
a memory, configured to store instructions executable by a processor; and
the processor, connected to the memory respectively;
where the processor is configured to execute the PUCCH transmission method

provided by any of the foregoing technical solutions.

The processor may include various types of storage media, which are non-transitory computer storage media and can continue to store information stored thereon after the communication device is powered off.

Here, the communication device includes: a terminal or a network element, and the network element may be any one of the aforementioned first to fourth network elements.

The processor may be connected to the memory through a bus or the like, and be configured to read the executable program stored in the memory, for example, at least one of the methods shown in FIG. 2, FIG. 5 to FIG. 9.

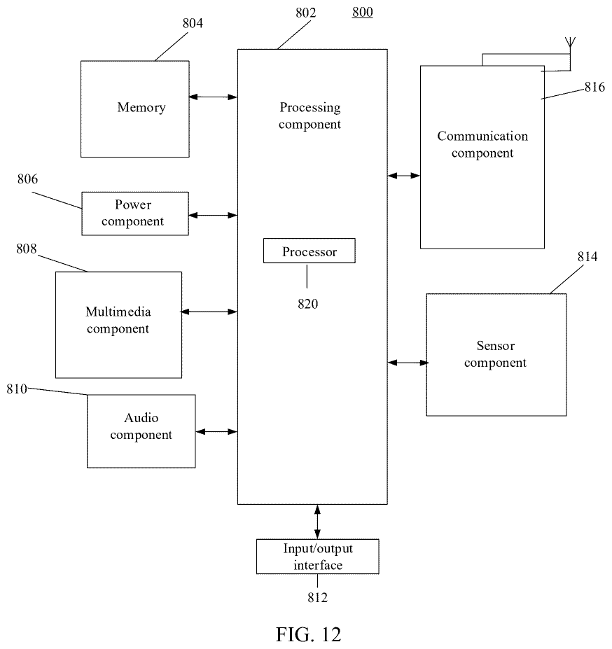

FIG. 12 is a block diagram of a terminal 800 according to an exemplary embodiment. For example, the terminal 800 may be a mobile phone, a computer, a digital broadcast user equipment, a messaging device, a gaming console, a tablet, a medical device, exercise equipment, a personal digital assistant, and the like.

Referring to FIG. 12, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the device 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the terminal 800, for performing the above-described methods. For example, the non-transitory computer-readable storage medium may be a ROM, a RAM, a CD-ROM, a magnetic tape, a floppy disc, an optical data storage device, and the like.

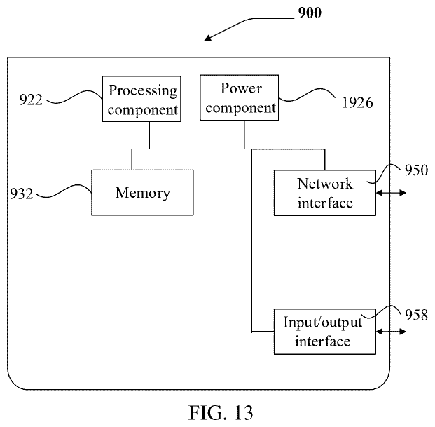

As shown in FIG. 13, an embodiment of the present disclosure illustrates a structure of a communication device 900. For example, the communication device 900 may be provided as a network side device. The communication device 900 may be the above-mentioned base station.

Referring to FIG. 13, the communication device 900 includes a processing component 922, which further includes one or more processors, and a memory resource represented by a memory 932 for storing instructions executable by the processing component 922, such as an application program. The application program stored in the memory 932 may include one or more modules, each corresponding to a set of instructions. In addition, the processing component 922 is configured to execute instructions to perform any of the aforementioned methods executed by the base station, such as at least one of the methods as shown in FIGS. 2 and 5 to 9.

The communication device 900 may further include a power component 926 configured to perform power management of the communication device 900, a wired or wireless network interface 950 configured to connect the communication device 900 to a network, and an input/output (I/O) interface 958. The communication device 900 may operate based on an operating system stored in the memory 932, such as a Windows Server™, a Mac OS X™, a Unix™, a Linux™, a Free BSD™ or the like.

Other embodiments of the present disclosure will be apparent to those skilled in the art from consideration of the specification and practice of the contents disclosed here. The present disclosure is intended to cover any variations, uses, or adaptations of the present disclosure, which follows the general principles thereof and includes the common knowledge or habitual technical means in this technical field that is not disclosed in the present disclosure. The specification and embodiments are considered as exemplary only, with a true scope and spirit of the present disclosure being indicated by the appending claims.

It will be appreciated that the present disclosure is not limited to the exact construction that has been described above and illustrated in the accompanying drawings, and various modifications and changes can be made without departing from the scope thereof. The scope of the present disclosure is only limited by the appended claims.

1. A Physical Uplink-Control Channel (PUCCH) transmission method, comprising:
according to a transmission configuration indication (TCI), performing, by a terminal, a non coherent-joint transmission (NC-JT) of a PUCCH by multiple antenna panels of the terminal based on frequency division multiplexing (FDM), wherein different antenna panels correspond to different TCIs.

2. The method according to claim 1, wherein different antenna panels face different transmission reception points (TRPs) of a base station;
time domain resources associated with different TCIs are the same, and frequency domain resources associated with different TCIs do not overlap;
demodulation reference signal (DMRS) ports associated with different TCIs are the same; or
precoding matrices associated with different TCIs are independent.

3-5. (canceled)

6. The method according to claim 1, wherein the multiple antenna panels of the terminal perform the NC-JT of the PUCCH based on FDM within one PUCCH resource.

7. (canceled)

8. The method according to claim 6, wherein
physical resource blocks (PRBs) corresponding to any one of the multiple antenna panels of the terminal are continuously distributed in a frequency domain;
or,
PRBs corresponding to the multiple antenna panels of the terminal are distributed at intervals in a frequency domain.

9. The method according to claim 6, wherein the method further comprises:
according to a predefined allocation pattern, determining, by the terminal, a frequency domain resource corresponding to the NC-JT of the PUCCH performed by different antenna panels;
receiving, by the terminal, a radio resource control (RRC) signaling, wherein the RRC signaling comprises a starting PRB of a frequency domain resource corresponding to at least one of the multiple antenna panels; and
according to the RRC signaling, determining, by the terminal, a frequency domain resource used by the multiple antenna panels of the terminal, wherein PRBs used by any one of the multiple antenna panels of the terminal are continuously distributed in a frequency domain;
or the method further comprises:
receiving, by the terminal, frequency hopping transmission indication information, wherein the frequency hopping transmission indication information comprises: a frequency hopping indication bit, configured to indicate the terminal to disable frequency hopping transmission; or a frequency hopping starting PRB indication, configured for the terminal to determine a starting PRB of a frequency domain resource used by at least one of the multiple antenna panels, wherein PRBs used by any one of the multiple antenna panels of the terminal are continuously distributed in a frequency domain;
or the method further comprises:
receiving, by the terminal, update information of a frequency domain resource parameter allocation used by the multiple antenna panels; and according to the updated information, determining, by the terminal, a frequency domain resource used by the multiple antenna panels of the terminal, wherein receiving the update information of the frequency domain resource parameter allocation used by the multiple antenna panels comprises: receiving, by the terminal, a media access control-control element (MAC-CE) containing the updated information.

10-12. (canceled)

13. The method according to claim 6, wherein a format of the PUCCH transmission is: a format 2 or a format 3, or
a type of the PUCCH transmission comprises any one of following transmissions:
a PUCCH transmission that does not support a repeated transmission;
a PUCCH repeated transmission based on intra-slot frequency hopping; or
a PUCCH repeated transmission based on inter-slot frequency hopping.

14-15. (canceled)

16. The method according to claim 1, wherein the multiple antenna panels of the terminal perform the NC-JT of the PUCCH based on FDM between different PUCCH resources;
wherein different PUCCH resources have a same time domain position and different frequency domain positions;
wherein the multiple antenna panels of the terminal perform the NC-JT of the PUCCH based on FDM between different PUCCH resources within a same PUCCH resource group; or, the multiple antenna panels of the terminal perform the NC-JT of the PUCCH based on FDM between different PUCCH resources in different PUCCH resource groups;
wherein any two of the PUCCH resources in one PUCCH resource group have a same time domain position and different frequency domain positions;
wherein a type of the PUCCH transmission comprises one of following types:
a PUCCH repeated transmission based on intra-slot frequency hopping; or
a PUCCH repeated transmission based on inter-slot frequency hopping; wherein repeated transmission time domain configuration parameters of any two of the PUCCH resources are the same.

17-18. (canceled)

19. The method according to claim 1, wherein according to the transmission configuration indication (TCI), performing the non coherent-joint transmission (NC-JT) of PUCCH by the multiple antenna panels of the terminal based on frequency division multiplexing (FDM), comprises:
performing the NC-JT of PUCCH by different antenna panels of the terminal based on FDM according to a corresponding TCI and target code rate;
wherein the PUCCH transmission comprises: a PUCCH transmission scheduled by single-downlink control information (S-DCI);
wherein the TCI comprises any one of following information: a joint TCI; a separate TCI; or spatial relation information;
wherein indication information of the TCI has a plurality of TCI fields, one of the TCI fields indicating a TCI corresponding to one antenna panel of the terminal, or indication information of the TCI has one TCI field, different code points of the TCI field indicating TCIs corresponding to different antenna panels of the terminal;
wherein the TCI is carried by any one of following signalings: downlink control information (DCI); media access control-control element (MAC-CE); or a radio resource control (RRC) signaling.

20-24. (canceled)

25. A PUCCH transmission method, comprising:
receiving, by a base station, a non coherent-joint transmission (NC-JT) of a PUCCH performed by multiple antenna panels of one terminal based on frequency division multiplexing (FDM), wherein different antenna panels correspond to different transmission configuration indications (TCIs).

26. The method according to claim 25, wherein different antenna panels face different transmission reception points (TRPs) of the base station;
time domain resources associated with different TCIs are the same, and frequency domain resources associated with different TCIs do not overlap;
demodulation reference signal (DMRS) ports associated with different TCIs are the same; or
precoding matrices associated with different TCIs are independent.

27-29. (canceled)

30. The method according to claim 25, wherein receiving the NC-JT of the PUCCH performed by the multiple antenna panels of one terminal based on frequency division multiplexing (FDM), comprises:
receiving the NC-JT of the PUCCH performed by the multiple antenna panels of one terminal based on FDM within one PUCCH resource.

31. The method according to claim 30, further comprising at least one of following operations:
according to a predefined allocation pattern, determining, by the base station, frequency domain resources used by different antenna panels for performing the NC-JT of the PUCCH;
sending, by the base station, frequency domain resource configuration information; wherein the frequency domain resource configuration information indicates that: physical resource blocks (PRBs) corresponding to any one of the multiple antenna panels of the terminal are continuously distributed in a frequency domain, or PRBs corresponding to the multiple antenna panels of the terminal are distributed at intervals in the frequency domain;
sending, by the base station, a radio resource control (RRC) signaling indicating a frequency domain resource used by the multiple antenna panels of the terminal, wherein the RRC signaling comprises a starting PRB of a frequency domain resource corresponding to at least one of the multiple antenna panels; and PRBs used by any one of the multiple antenna panels of the terminal are continuously distributed in a frequency domain;
sending, by the base station, frequency hopping transmission indication information, wherein the frequency hopping transmission indication information comprises: a frequency hopping indication bit, configured to indicate the terminal to disable frequency hopping transmission; or a frequency hopping starting PRB indication, configured for the terminal to determine a starting PRB of a frequency domain resource used by at least one of the multiple antenna panels, wherein PRBs used by any one of the multiple antenna panels of the terminal are continuously distributed in a frequency domain; or
sending, by the base station, update information; wherein the update information is configured to determine a frequency domain resource parameter allocation used by the multiple antenna panels,
wherein sending the update information comprises: sending a media access control-control element (MAC-CE) containing the updated information.

32-36. (canceled)

37. The method according to claim 30, wherein a format of the PUCCH transmission is: a format 2 or a format 3 or
a type of the PUCCH transmission comprises any one of following types:
a PUCCH transmission that does not support a repeated transmission;
a PUCCH repeated transmission based on intra-slot frequency hopping; or
a PUCCH repeated transmission based on inter-slot frequency hopping.

38-39. (canceled)

40. The method according to claim 25, wherein receiving the non coherent-joint transmission (NC-JT) of the PUCCH performed by the multiple antenna panels of one terminal based on frequency division multiplexing (FDM), comprises:
receiving the NC-JT of the PUCCH performed by the multiple antenna panels of one terminal based on FDM between different PUCCH resources;
wherein different PUCCH resources have a same time domain position and different frequency domain positions;
wherein receiving the NC-JT of the PUCCH performed by the multiple antenna panels of one terminal based on FDM between different PUCCH resources comprises: receiving the NC-JT of the PUCCH performed by the multiple antenna panels of one terminal based on FDM between different PUCCH resources within a same PUCCH resource group; or, receiving the NC-JT of the PUCCH performed by the multiple antenna panels of one terminal based on FDM between different PUCCH resources within different PUCCH resource groups;
wherein any two of the PUCCH resources in one PUCCH resource group have a same time domain position and different frequency domain positions;
wherein a type of the PUCCH transmission comprises one of following types:
a PUCCH repeated transmission based on intra-slot frequency hopping; or
a PUCCH repeated transmission based on inter-slot frequency hopping; wherein repeated transmission time domain configuration parameters of any two of the PUCCH resources are the same.

41-42. (canceled)

43. The method according to claim 25, further comprising at least one of following operations:
sending, by the base station, target code rate configuration information; wherein the target code rate indicated by the target code rate configuration information and the TCI are used for the terminal to perform the NC-JT of the PUCCH based on FDM; or
sending, by the base station, single-downlink control information (S-DCI); wherein the S-DCI is configured to schedule a transmission of the PUCCH.

44. (canceled)

45. The method according to claim 25, wherein the TCI comprises any one of following information:
a joint TCI;
a separate TCI; or
spatial relation information.

46. The method according to claim 25, wherein indication information of the TCI has a plurality of TCI fields;
one of the TCI fields indicating a TCI corresponding to one antenna panel of the terminal;
or
indication information of the TCI has one TCI field, different code points of the TCI field indicating TCIs corresponding to different antenna panels of the terminal.

47. (canceled)

48. The method according to claim 25, wherein the TCI is carried by any one of following signalings:
downlink control information (DCI);
media access control-control element (MAC-CE); or
a radio resource control (RRC) signaling.

49. A PUCCH transmission apparatus, which is applied to a terminal, wherein the apparatus comprises:
a processor; and
a memory for storing instructions executable by the processor;
wherein the processor is configured to:
perform a non coherent-joint transmission (NC-JT) of a PUCCH based on frequency division multiplexing (FDM) through multiple antenna panels of the terminal according to a transmission configuration indication (TCI); wherein different antenna panels correspond to different TCIs.

50. A PUCCH transmission apparatus, which is applied to a base station, wherein the apparatus comprises:
a processor; and
a memory for storing instructions executable by the processor;
wherein the processor is configured to execute the PUCCH transmission method according to claim 25.

51-52. (canceled)
